(19) United States
(12) Patent Application Publication
(10) Pub. No.: US 2025/0179833 A1
(43) Pub. Date: Jun. 5, 2025

(54) Security System for Locks

(71) Applicant: Salto Systems, S.L., Oiartzun (ES)

(72) Inventors: Carlos Ferreira Sánchez, Oiartzun (ES); Javier Lecaroz Amunarriz, Oiartzun (ES)

(21) Appl. No.: 18/843,450

(22) PCT Filed: Mar. 3, 2023
(86) PCT No.: PCT/ES2023/070119

§ 371 Date: Sep. 3, 2024

(30) Foreign Application Priority Data
Mar. 4, 2022 (ES) P202230179
Apr. 13, 2022 (ES) P202230334

(51) Int. Cl. E05B 13/00; E05B 17/20

(52) U.S. Cl. CPC E05B 13/004; E05B 17/2092

(57) ABSTRACT

The present relates to a security system for locks having a latch, a follower a recess, an interaction element configured for being inserted into the recess and a hinged locking element a hinge shaft, a support portion and a locking portion.

### CROSS-REFERENCE TO RELATED APPLICATIONS

This application is the United States national phase of International Patent Application No. PCT/ES2023/070119 filed Mar. 3, 2023, and claims priority to Spanish Patent Application No. P202230179 filed Mar. 4, 2022 and Spanish Patent Application No. P202230334 filed Apr. 13, 2022, the disclosures of which are hereby incorporated by reference in their entireties.

### BACKGROUND OF THE INVENTION

### Field of the Invention

The present disclosure belongs to the technical field of locks.

More particularly, this disclosure relates to a security system for use in locks having a follower, preferably, in locks having a clutch mechanism or in locks having a locking mechanism, and that is intended to increase the security of said locks.

### Description of Related Art

There are two main types of barriers to prevent unauthorized access to the interior of a closed space: the access door and the lock locking said door.

The degree of security of the doors depends, broadly speaking, on two main factors: the type of design and the materials used to build the door. This has allowed the development of various types of doors depending on the degree of security desired, which vary from normal doors to armored and ironclad doors.

However, reinforcing a door is not effective without having a sufficiently strong lock against possible attacks.

Currently, in order to deal with the new techniques of unauthorized lock manipulation, lock manufacturers and designers try to implement security systems that protect them from said unwanted manipulations.

One of the main difficulties when implementing novel security systems for locks is that said systems must be able to distinguish between normal operation of the lock and unwanted manipulation, so that said security system only acts when the lock is being subjected to an attack.

Moreover, additional security systems must be sufficiently compact in size to allow the installation thereof in the space available inside the lock, which is usually quite small.

The locks of interest in this case, which belong to the state of the art, are provided with a latch and a follower. The latch is a wedge-shaped element that is inserted into a hole provided in the door frame to keep the door closed, while the follower is a part that is responsible for transmitting the movement to the latch, during the opening of the door, to remove it from the hole in which it was previously housed and thus release the door.

Within the locks having a follower that are present in the state of the art, there are two different types for opening and/or closing them: those having a locking mechanism and those having a clutch mechanism.

The lock having the locking mechanism comprises a recess (or hole) made in the same follower and an interaction element (also called a lock) configured so that said interaction element is inserted into the recess, for example due to the action of a spring, preventing the rotation of the follower. This locking mechanism is also provided with means for releasing the interaction element which, when the lock receives an authorized opening command, displace the interaction element, removing it from the recess, releasing the follower and allowing its movement and that of the latch.

The lock having the clutch mechanism that is present in the state of the art comprises a follower made up of two elements, a drive follower, comprising a recess (or hole) made in the same drive follower, and a transmission follower.

Both followers are connected by means of an interaction element, configured such that, when the lock receives an authorized opening command, the interaction element is displaced, inserting it into the recess of the drive follower, thus connecting both followers (drive and transmission), allowing its movement and that of the latch.

If the locks having a follower (having a locking mechanism or having a clutch mechanism) do not receive an authorized order, the interaction element is not displaced, so that the follower does not allow the latch to be displaced.

The previously described systems present the problem that they can be manipulated thus allowing an unauthorized access. In fact, if sufficiently intense external vibrations are applied to the lock, the interaction element can be momentarily displaced with respect to the recess in the follower, so that the follower allows unauthorized movement of the latch.

In light of this, there is a need in the sector to develop novel security systems for locks that are difficult to manipulate.

### SUMMARY OF THE INVENTION

The present disclosure intends to address the aforementioned problems of the opening and/or closing systems for locks of the art described above, through a security system that allows the protection of said opening and/or closing systems.

To this end, a first object of the disclosure relates to a security system for locks, wherein the lock comprises:
a latch,
a follower configured to rotate and transmit an opening movement to the latch, wherein the follower comprises a recess, and
an interaction element configured for being inserted in the recess of the follower.

Likewise, the security system comprises a hinged locking element, said hinged locking element comprising a hinge shaft, a support portion and a locking portion, said hinged locking element being configured to rotate around the hinge shaft and lock the interaction element through the locking portion.

In a particular embodiment, the hinged locking element is sized so that it meets the following geometric condition:

$$L 1 \times H > L 2 \times X$$

wherein:
(L1) is the distance between the hinge shaft and the first point of contact of the locking portion with the interaction element;
(H) is the minimum distance that the interaction element moves to allow the movement of the follower;
(L2) is the distance between the hinge shaft and a support point, configured for supporting the support portion, and
(X) is the minimum displacement distance of the hinged locking element to lock the interaction element after its rotation about the hinge shaft.

The security system object of the present disclosure prevents the movement of the interaction element in the event of malicious vibrations.

More particularly, due to the specific configuration of the hinged locking element described above, at the moment when the lock experiences vibrations the intensity of which exceeds a predefined threshold, these same vibrations cause the hinged locking element to rotate about the hinge shaft thereof so that the locking portion comes into contact with the interaction element preventing its movement. In this situation, the door remains closed since the follower cannot transfer the opening movement to the latch, which therefore remains in the hole provided in the door frame.

In the absence of vibrations, the hinged locking element is in a rest position, supported on a support point belonging to the lock. This allows the follower to move when receiving an authorized opening command. On the contrary, if undesired manipulation such as a vibration with sufficient intensity occurs, said vibration will cause the hinged locking element to rotate around the hinge shaft, coming into contact with the interaction element, preventing its movement and causing it to thus continue immobilizing the follower.

In a particular embodiment, said support point belongs to an area of the follower.

In a particular embodiment, said support point belongs to an area of the lock that remains fixed.

Moreover, for the system to work correctly, the distance (X) that the hinged locking element must be displaced to start locking the interaction element after its rotation about the hinge shaft must be greater than zero (i.e., X>0) since, otherwise, the locking portion would lock the interaction element even when said hinged locking element is in its rest position. In addition, it is preferable that (X) has a value above a predefined threshold to prevent the security system from erroneously activating the hinged locking element when small external disturbances occur, such as slamming doors.

Likewise, before the interaction element is sufficiently displaced as to allow the movement of the follower (minimum distance H), the locking portion must rotate enough to block the interaction element (i.e., it must rotate at least one distance X), for this the following must be met:

$$1 - \frac{d H}{H} > 1 - \frac{d X}{X}$$

Wherein dH is the linear displacement of the interaction element.
Wherein dX is the displacement of the locking portion of the hinged locking element.

To develop the security system according to the present disclosure, it has been taken into account that the variation of X depends on the rotation of the locking portion of the hinged locking element, therefore it is possible to resemble said rotation to a linear displacement in the direction X, arriving at the following formula:

$$d X = L 1 \times d α$$

wherein dα is the angular displacement of the locking portion of the hinged locking element in radians.

Likewise, the displacement of the interaction element is related to the rotation of the locking portion of the hinged locking element as follows: Bearing in mind that the displacements of the parts of the security system are small and that their masses are negligible, compared to the impact (or vibration) exerted from the outside, and that said impact is transmitted in the same manner to the interaction element than to the hinged locking element on its support point at one end (L2 being the distance between the hinge shaft of the hinged locking element and the support point configured to support the support portion), that support point is displaced like the interaction element in a linear manner.

Taking the above into account, we arrive at the following formula:

$$d H = L 2 \times d α \to d α = \frac{d H}{L 2}$$

Combining all the previous expressions, we arrive at the following formula:

$$\frac{H - L 2 \times d α}{H} > \frac{X - L 1 \times d α}{X} .$$

Which by simplifying terms translates into the following final formula:

$$L 1 \times H > L 2 \times X$$

According to this last formula, the smaller the difference between (L1) and (L2), while the design allows it, the better the security system works.

In turn, the greater the distance (H) that the interaction element must be displaced to allow the movement of the follower, the greater margin the safety system has for its proper functioning.

Finally, the smaller the distance (X), the better the system works, as long as the above requirements are met.

Preferably, the mass of the support portion of the hinged locking element is greater than the mass of the locking portion of the hinged locking element. It is thus facilitated that, when an impact or vibration occurs, the hinged locking element prevents the interaction element from continuing to be displaced.

A second object of the disclosure relates to a lock comprising a latch, a follower configured to rotate and transmit an opening movement to the latch, wherein the follower comprises a recess, and an interaction element configured for being inserted into the recess of the follower, and wherein the lock is provided with a security system according to the first aspect of the disclosure.

### BRIEF DESCRIPTION OF THE DRAWINGS

What follows is a very brief description of a series of drawings that aid in better understanding the disclosure, which are expressly related to an embodiment of said disclosure and are presented by way of non-limiting examples of the same.

FIG. 1 is a cross-sectional view of a security system for locks according to the present disclosure, in particular for a lock having a locking mechanism, wherein the interaction element does not immobilize the follower of the lock;

FIG. 2 is a cross-sectional view of the security system of FIG. 1, wherein the interaction element is immobilizing the follower of the lock;

FIG. 3 is a cross-sectional view of the security system of FIG. 1, wherein, after a vibration of sufficient intensity, the hinged locking element has been activated for locking the interaction element;

FIG. 4 is a cross-sectional view of a security system for locks according to the present disclosure, in particular for a lock having a clutch mechanism, wherein the interaction element does not immobilise the follower of the lock;

FIG. 5 is a cross-sectional view of the security system of FIG. 4, wherein the interaction element is immobilising the follower of the lock; and

FIG. 6 is a cross-sectional view of the security system of FIG. 4, wherein, after a vibration of sufficient intensity, the hinged locking element has been activated for locking the interaction element.

### NUMERICAL REFERENCES OF THE DRAWINGS

(1) Latch (of the lock);
(2) Follower (of the lock);
(2a) Drive follower;
(2b) Transmission follower;
(3) Recess (provided in the follower);
(4) Interaction element;
(5) Hinged locking element;
(5a) Support portion (of the hinged locking element);
(5b) Locking portion (of the hinged locking element);
(6) Hinge shaft;
(7) Spring responsible for loading the latch;
(L1) Distance between the hinge shaft and the first point of contact of the locking portion with the interaction element;
(H) Minimum distance that the interaction element moves to allow the movement of the follower;
(L2) Distance between the hinge shaft and a support point configured for supporting the support portion;
(X) Minimum displacement distance required to lock the interaction element by the hinged locking element after the rotation thereof about the hinge shaft; and
(α) Angle of rotation of the locking portion.

### DESCRIPTION OF THE INVENTION

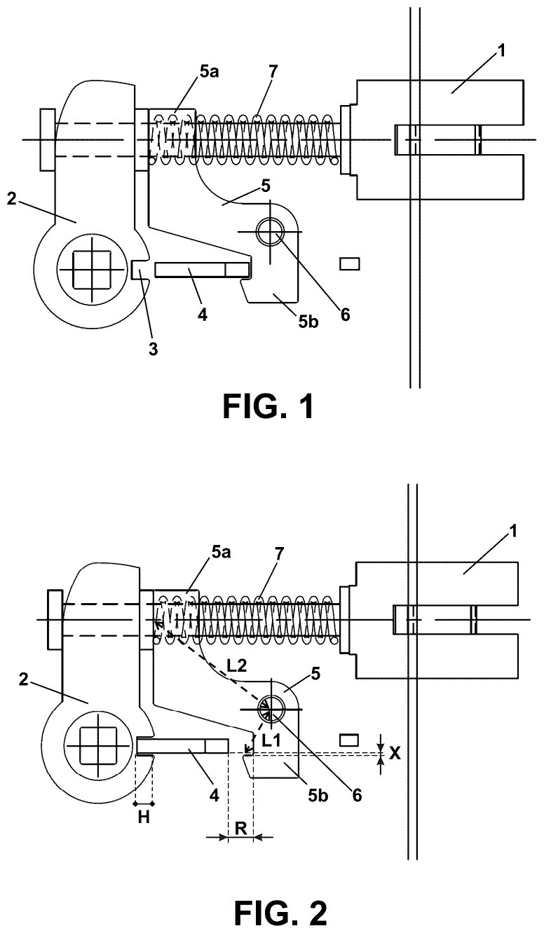

FIG. 1 shows an embodiment of a security system for a lock having a follower according to the present disclosure, the same having a locking mechanism.

Said lock is provided with a latch (1) loaded by a spring (7), which pushes the latch (1) so that it is inserted into a hole provided in the door frame, keeping the door closed. The lock is also provided with a follower (2) responsible for transmitting the movement to the latch (1), during the opening of the door, to extract it from the hole in which it was previously housed and thus open the door.

The security system according to the disclosure comprises a recess (3) made in the same follower (2), as shown in FIG. 2. It also shows an interaction element (4) intended for being inserted into the recess (3).

In the configuration illustrated in FIG. 1, said interaction element (4) is in an unlocked position, i.e., it is not housed inside the recess (3), so that it is possible to open the door. This configuration corresponds to the case in which the lock receives an authorized opening order.

In addition, the security system according to the disclosure is provided with a hinged locking element (5) provided with a hinge shaft (6). The hinged locking element (5) further comprises a support portion (5a) and a locking portion (5b).

FIG. 2 shows the security system of FIG. 1, in a configuration wherein the interaction element (4) is in its locked position, i.e., it is housed in the recess (3) such that it prevents the rotation of the follower (2) and thus, the opening of the door. Said figure further illustrates the geometric distances L1 (distance between the hinge shaft (6) and the point of the locking portion (5b) that makes contact with the interaction element (4)), L2 (distance between the hinge shaft (6) and the resting point of the support portion (5a)), X (minimum rotation distance required to lock the interaction element (4)) and H (distance that the interaction element (4) is displaced to allow the movement of the follower (2)) that geometrically determine the hinged locking element (5).

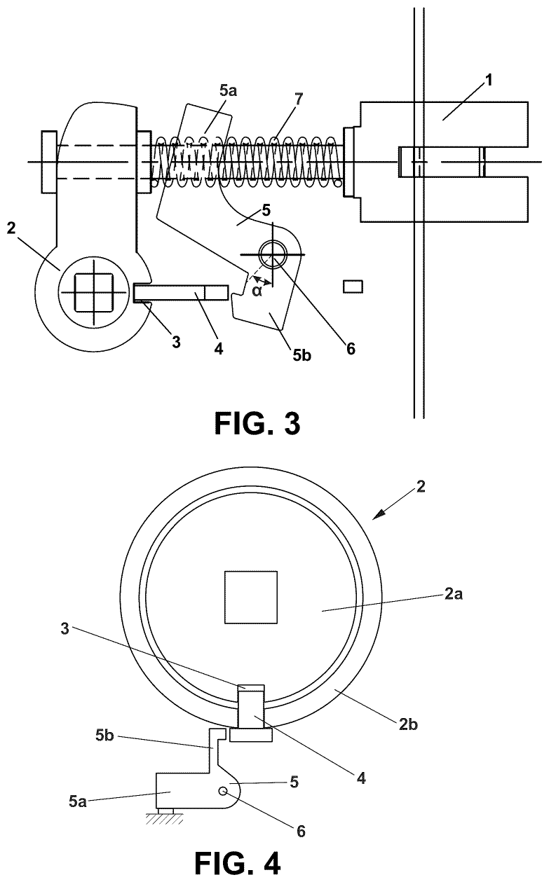

Lastly, FIG. 3 shows the security system of FIG. 1 when a malicious vibration of sufficient intensity has occurred to activate the hinged locking element (5). In this case, the vibration causes the hinged locking element (5) to rotate about the hinge shaft (6), such that the locking portion (5b) comes into contact with the interaction element (4) preventing same from coming out of the recess (3), thus keeping the follower (2) locked and avoiding an unauthorized opening of the lock.

Also illustrated, with the reference (a), is the angle described by the hinged locking element (5) during this rotational movement.

FIG. 4 shows an embodiment of a security system for a lock having a follower according to the present disclosure, the same having a clutch mechanism.

Said lock is provided with a latch (1) (not depicted), which is inserted into a hole provided in the door frame, keeping the door closed. The lock is also provided with a follower (2) responsible for transmitting the movement to the latch (1), during the opening of the door, to extract it from the hole in which it was previously housed and thus open the door. In this embodiment, the follower comprises a drive follower (2a) and a transmission follower (2b).

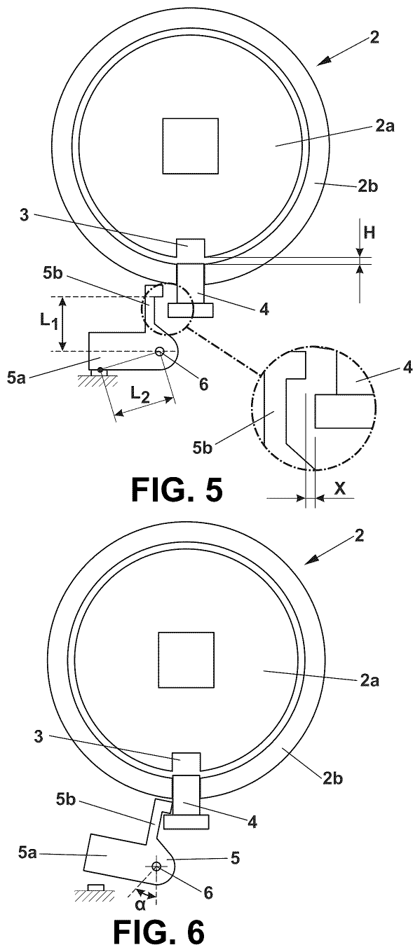

The security system according to the disclosure comprises a recess (3) made in the drive follower (2a), as shown in FIG. 5. It also shows an interaction element (4) intended to be housed in the recess (3).

In the configuration illustrated in FIG. 4, said interaction element (4) is in an unlocked position, i.e., it is housed inside the recess (3), so that the drive follower (2a) and the transmission follower (2b) are connected to each other, due to the interaction element (4), so that it is possible to open the door. This configuration corresponds to the case in which the lock receives an authorized opening order.

In addition, the security system according to the disclosure is provided with a hinged locking element (5) provided with a hinge shaft (6). The hinged locking element (5) further comprises a support portion (5a) and a locking portion (5b).

FIG. 5 shows the security system of FIG. 4, in a configuration wherein the interaction element (4) is in its locked position, i.e., it is outside the recess (3) such that it prevents the rotation of the follower (2), since the drive follower (2a) and the transmission follower (2b) are not connected to each other, and thus, the door is prevented from opening.

Said figure further illustrates the geometric distances L1 (distance between the hinge shaft (6) and the point of the locking portion (5b) that makes contact with the interaction element (4)), L2 (distance between the hinge shaft (6) and the resting point of the support portion (5a)), X (minimum rotation distance required to lock the interaction element (4)) and H (distance that the interaction element (4) is displaced to allow the movement of the follower (2)) that geometrically determine the hinged locking element (5).

Lastly, FIG. 6 shows the security system of FIG. 4 when a malicious vibration of sufficient intensity has occurred to activate the hinged locking element (5). In this case, the vibration causes the hinged locking element (5) to rotate about the hinge shaft (6), such that the locking portion (5b) comes into contact with the interaction element (4) preventing same from being inserted into the recess (3), thus keeping the follower (2) locked, by not allowing the connection between the drive follower (2a) and the transmission follower (2b) and avoiding an unauthorized opening of the lock.

Also illustrated, with the reference (a), is the angle described by the hinged locking element (5) during this rotational movement about the hinge shaft (6).

The disclosure should not be limited to the particular embodiment described herein. Persons skilled in the art can develop other embodiments in view of the description made herein. Accordingly, the scope of the disclosure is defined by the following claims.

1. A security system for locks, wherein the lock comprises:
a latch,
a follower configured to rotate and transmit an opening movement to the latch, wherein the follower comprises a recess, and
an interaction element configured for being inserted in the recess of the follower,
said security system comprises a hinged locking element, said hinged locking element comprising a hinge shaft, a support portion and a locking portion, said hinged locking element being configured to rotate about the hinge shaft and lock the interaction element by means of the locking portion.

2. The security system for locks according to, wherein the hinged locking element is sized so that it meets the following condition:
$$L 1 \times H > L 2 \times X$$
wherein:
(L1) is the distance between the hinge shaft and the first point of contact of the locking portion with the interaction element;
(H) is the minimum distance that the interaction element moves to allow the movement of the follower;
(L2) is the distance between the hinge shaft and a support point, configured for supporting the support portion;
(X) is the minimum displacement distance of the hinged locking element for locking the interaction element after the rotation thereof about the hinge shaft.

3. The security system for locks according to, wherein the follower comprises a drive follower and a transmission follower.

4. The security system for locks according to claim 3, wherein the recess is in the drive follower.

5. The security system for locks according to wherein the mass of the support portion of the hinged locking element is greater than the mass of the locking portion of the hinged locking element.

6. A lock comprising a latch, a follower configured to rotate and transmit an opening movement to the latch, wherein the follower comprises a recess, and an interaction element configured for being inserted into the recess of the follower, it further comprises a security system according to.
